(19) United States
(12) Patent Application Publication
(10) Pub. No.: US 2026/0186255 A1
(43) Pub. Date: Jul. 2, 2026

(54) CAMERA OPTICAL LENS

(71) Applicant: Changzhou AAC Raytech Optronics Co., Ltd., Changzhou City (CN)

(72) Inventor: Yuyi Liu, Changzhou (CN)

(21) Appl. No.: 19/333,366

(22) Filed: Sep. 19, 2025

Related U.S. Application Data
(63) Continuation of application No. PCT/CN2024/142990, filed on Dec. 27, 2024.

(51) Int. Cl. G02B 13/00; G02B 9/60

(52) U.S. Cl. CPC G02B 13/0045; G02B 9/60

(57) ABSTRACT

Provided is a camera optical lens including: first lens having positive refractive power, second lens having negative refractive power, third lens having negative refractive power, fourth lens having negative refractive power, and fifth lens having positive refractive power. A focal length f of the camera optical lens, a total track length TTL, an on-axis distance d2 from an image side surface of the first lens to an object side surface of the second lens, a focal length f4 of the fourth lens, a central curvature radius R7 of an object side surface of the fourth lens, and a central curvature radius R8 of an image side surface of the fourth lens satisfy following relational expressions: 0.75≤TTL/f≤0.84; 2.99≤(d2/f)*100≤15.00; and −0.40≤f4/(R7−R8)≤−0.05. The camera optical lens has excellent optical characteristics, as well as large aperture, wide-angle and ultra-thin characteristics.

### TECHNICAL FIELD

The present disclosure relates to the field of optical lenses, and in particular, to a camera optical lens suitable for handheld terminal devices such as smart phones and digital cameras, and camera apparatus such as monitors and PC lenses.

### BACKGROUND

In recent years, with the rise of various smart devices, the demand for a miniaturized camera optical lens has gradually increased. Moreover, since a pixel size of a photosensitive device is reduced, and the current electronic product has a development trend towards having good functions and an appearance of thin, light and portable, the miniaturized camera optical lens having good imaging quality has become a mainstream in the current market. In order to obtain better imaging quality, a multi-lens structure is mostly adopted. In addition, with the development of technology and the increase of diversified requirements of users, under the conditions that a pixel area of the photosensitive device continues to shrink and the requirement on the imaging quality of the system are continuously improving, a five-lens structure has been gradually adopted in the lens design. There is an urgent need for a wide-angle camera optical lens having excellent optical characteristics with small volume and fully corrected aberrations.

### SUMMARY

In view of the above problems, a main object of the present disclosure is to provide a camera optical lens, which has good optical performance and meets design requirements of large aperture, ultra-thin and wide-angle.

In order to achieve the above object, an embodiment of the present disclosure provides a camera optical lens, including from an object side to an image side: a first lens having a positive refractive power, a second lens having a negative refractive power, a third lens having a negative refractive power, a fourth lens having a negative refractive power, and a fifth lens having a positive refractive power. A focal length of the camera optical lens is f, a total track length of the camera optical lens is TTL, an on-axis distance from an image side surface of the first lens to an object side surface of the second lens is d2, a focal length of the fourth lens is f4, a central curvature radius of an object side surface of the fourth lens is R7, and a central curvature radius of an image side surface of the fourth lens is R8, and following relational expressions are satisfied: 0.75≤TTL/f≤0.84; 3≤(d2/f)*100≤15.00; and −0.4≤f4/(R7−R8)≤−0.05.

As an improvement, an image height of the camera optical lens is IH, and a following relational expression is satisfied: 65.49≤(43.25/(2*IH))*f≤71.5.

As an improvement, a focal length of the fifth lens is f5, and a following relational expression is satisfied: −1.05≤f4/f5≤−0.40.

As an improvement, −1.03≤f4/f5≤−0.40.

As an improvement, an object side surface of the first lens is convex in a paraxial region. A focal length of the first lens is f1, a central curvature radius of the object side surface of the first lens is R1, a central curvature radius of the image side surface of the first lens is R2, and an on-axis thickness of the first lens is d1, and following relational expressions are satisfied: 0.44≤f1/f≤0.49; −1.04≤(R1+R2)/(R1−R2)≤−0.77; and 0.145≤d1/TTL≤0.244.

As an improvement, the object side surface of the second lens is convex in a paraxial region, and an image side surface of the second lens is concave in the paraxial region. A focal length of the second lens is f2, a central curvature radius of the object side surface of the second lens is R3, a central curvature radius of an image side surface of the second lens is R4, and an on-axis thickness of the second lens is d3, and following relational expressions are satisfied: −1.43≤f2/f≤−0.65; 1.53≤(R3+R4)/(R3−R4)≤2.82; and 0.026≤d3/TTL≤0.033.

As an improvement, an image side surface of the third lens is concave in a paraxial region. A focal length of the third lens is f3, a central curvature radius of an object side surface of the third lens is R5, a central curvature radius of the image side surface of the third lens is R6, and an on-axis thickness of the third lens is d5, and following relational expressions are satisfied: −1.20≤f3/f≤−0.83; 0.73≤(R5+R6)/(R5−R6)≤1.80; and 0.028≤d5/TTL≤0.039.

As an improvement, the object side surface of the fourth lens is concave in a paraxial region, and the image side surface of the fourth lens is convex in the paraxial region. An on-axis thickness of the fourth lens is d7, and following relational expressions are satisfied: −0.76≤f4/f≤−0.32; −1.37≤(R7+R8)/(R7−R8)≤−1.05; and 0.026≤d7/TTL≤0.038.

As an improvement, an image side surface of the fifth lens is convex in a paraxial region. A focal length of the fifth lens is f5, a central curvature radius of an object side surface of the fifth lens is R9, a central curvature radius of the image side surface of the fifth lens is R10, and an on-axis thickness of the fifth lens is d9, and following relational expressions are satisfied: 0.31≤f5/f≤1.90; −0.34≤(R9+R10)/(R9-R10)≤1.98; and 0.111≤d9/TTL≤0.163.

As an improvement, the first lens is made of glass.

The present disclosure has the following beneficial effects: the camera optical lens according to the present disclosure has excellent optical characteristics, as well as large aperture, wide-angle and ultra-thin characteristics, and is particularly suitable for a mobile phone camera optical lens assembly and a WEB camera optical lens composed of camera elements such as CCD and CMOS with high resolution.

### BRIEF DESCRIPTION OF DRAWINGS

In order to better illustrate the technical solutions in embodiments of the present disclosure, the drawings used in the description of the embodiments will be briefly described below. It is appreciated that, the drawings in the following description are only some embodiments of the present disclosure, and for those skilled in the art, other drawings may also be obtained according to these drawings without creative effort.

FIG. 1 is a schematic structural diagram of a camera optical lens according to a first embodiment of the present disclosure;

FIG. 2 is a schematic diagram of longitudinal aberration of the camera optical lens shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a schematic structural diagram of a camera optical lens according to a second embodiment of the present disclosure;

FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a schematic structural diagram of a camera optical lens according to a third embodiment of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9;

FIG. 13 is a schematic structural diagram of a camera optical lens according to a fourth embodiment of the present disclosure;

FIG. 14 is a schematic diagram of longitudinal aberration of the camera optical lens shown in FIG. 13;

FIG. 15 is a schematic diagram of lateral color of the camera optical lens shown in FIG. 13; and

FIG. 16 is a schematic diagram of field curvature and distortion of the camera optical lens shown in FIG. 13.

### DESCRIPTION OF EMBODIMENTS

In order to better illustrate objectives, technical solutions, and advantages of embodiments of the present disclosure, the technical solutions in the embodiments of the present disclosure are clearly and completely described in details with reference to the drawings. Those of ordinary skill in the art will appreciate that in various embodiments of the present disclosure, numerous technical details are set forth for the reader to better understand the present disclosure. However, even without these technical details and various variations and modifications based on the following embodiments, the technical solutions claimed in the present disclosure can still be implemented.

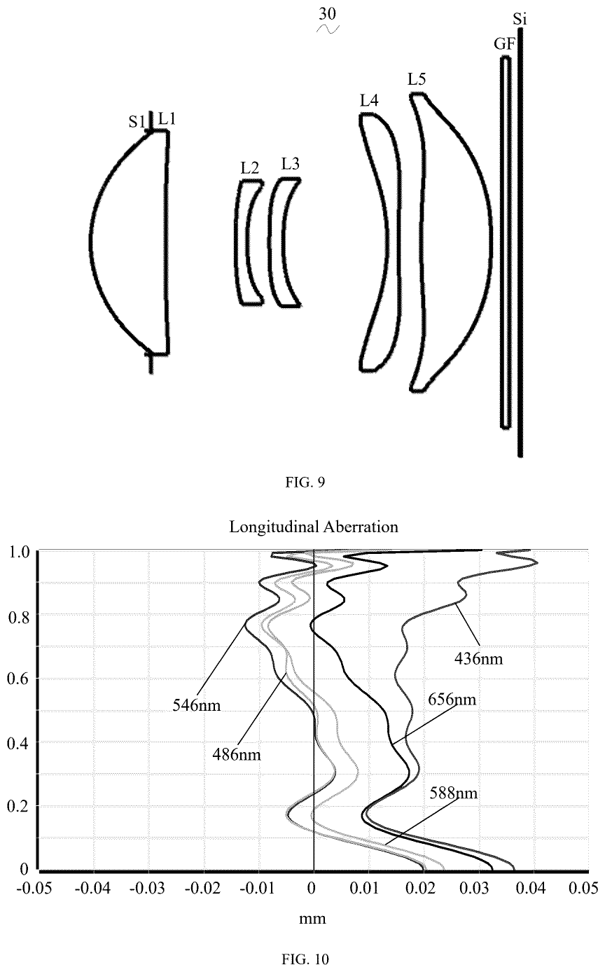

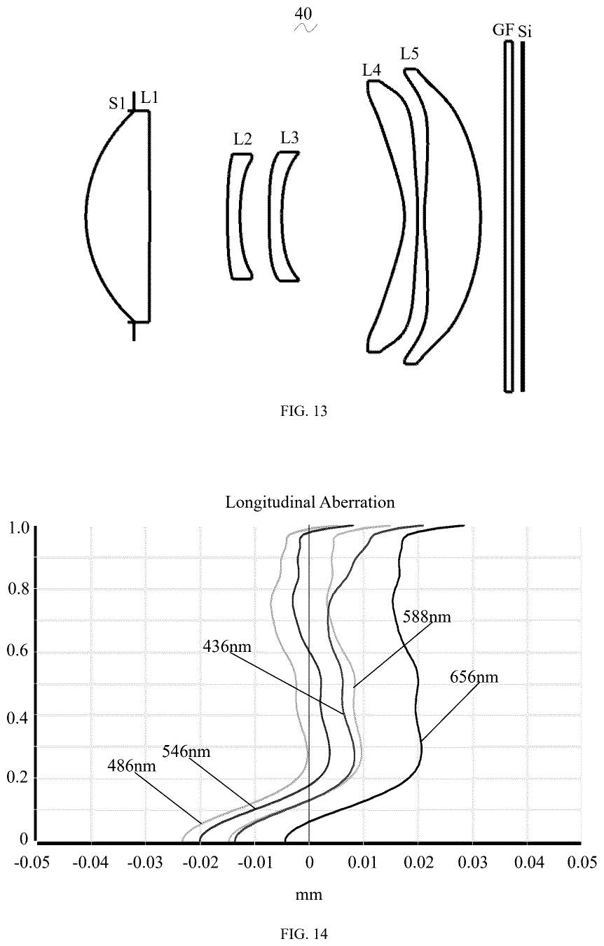

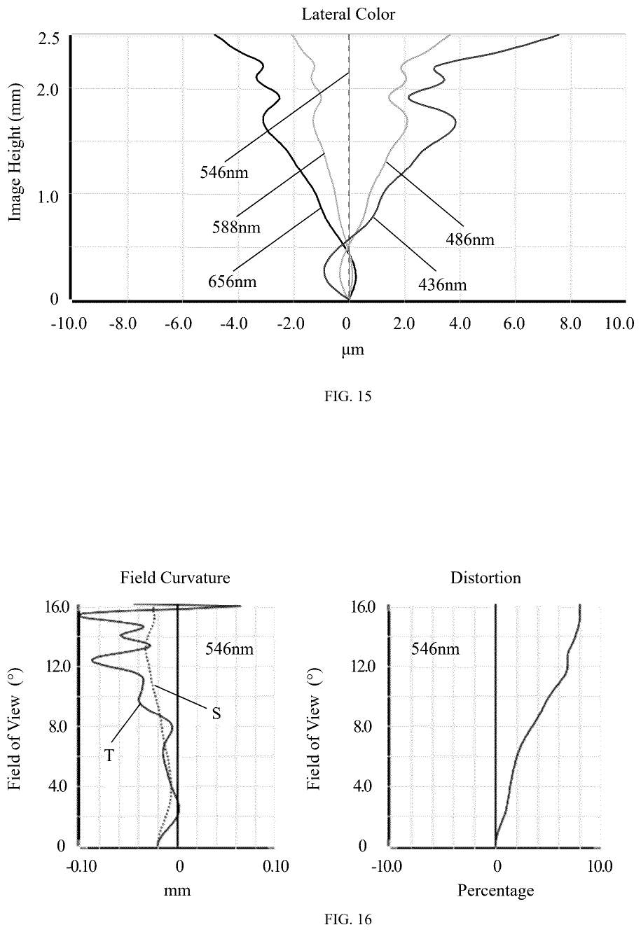

Referring to the drawings, embodiments of the present disclosure provide a camera optical lens 10, 20, 30 and 40. As shown in FIG. 1, FIG. 5, FIG. 9, and FIG. 13, the camera optical lens 10, 20, 30, and 40 according to the present disclosure includes from an object side to an image side: an aperture S1, a first lens L1, a second lens L2, a third lens L3, a fourth lens L4, and a fifth lens L5. An optical element such as a grating filter GF may be provided between the fifth lens L5 and an image plane Si.

A focal length of the camera optical lens 10, 20, 30 and 40 is defined as f, and a total track length of the camera optical lens 10, 20, 30 and 40 is defined as TTL, and the following relational expression is satisfied: 0.75≤TTL/f≤0.84. This relational expression specifies the ratio of the total track length of the camera optical lens 10, 20, 30 and 40 to the focal length of the camera optical lens 10, 20, 30 and 40. Setting the upper limit of the relational expression can control the total track length of the camera optical lens 10, 20, 30 and 40 to be shorter, so as to facilitate the miniaturization of the camera optical lens 10, 20, 30 and 40. Setting the lower limit of the relational expression is conducive to correcting distortion and axial chromatic aberration, thereby maintaining good optical performance.

An on-axis distance d2 from an image side surface of the first lens L1 to an object side surface of the second lens L2 is defined as d2, and the following relational expression is satisfied: 3≤(d2/f)*100≤15, which specifies the ratio of the on-axis distance from the image side surface of the first lens L1 to the object side surface of the second lens L2 to the focal length. Within the range specified by the relational expression, the aberrations can be effectively reduced, thereby ensuring that the performance of the entire system reaches the optimal state.

A focal length of the fourth lens L4 is defined as f4, a central curvature radius of an object side surface of the fourth lens L4 is defined as R7, and a central curvature radius of an image side surface of the fourth lens L4 is defined as R8, and the following relational expression is satisfied: −0.4≤f4/(R7−R8)≤−0.05. This relational expression specifies the ratio of the focal length of the fourth lens L4 to the difference between radii of the object side surface and the image side surface of the fourth lens L4, and specifies the surface shape of the fourth lens L4. Within the range specified by the relational expression, the sensitivity of the system can be effectively reduced, the stray light generated by the optical system can be reduced, and the imaging quality of the optical system can be improved, thereby enhancing the performance and reliability of the optical system, and reducing the production difficulty and cost.

When the above relational expressions are satisfied, the camera optical lens 10, 20, 30 and 40 has good optical performance and can satisfy the design requirements of large aperture, wide-angle and ultra-thin. According to the characteristics of the camera optical lens 10, 20, 30 and 40, the camera optical lens 10, 20, 30 and 40 are particularly suitable for the mobile phone camera optical lens assembly and the WEB camera optical lens composed of camera elements such as CCD and CMOS with high resolution.

Based on the above relational expressions and the achievable functions, the characteristics of each lens are further defined as follows.

An image height of the camera optical lens 10 is defined as IH, and the following relational expression is satisfied: 65.5≤(43.25/(2*IH))*f≤71.5. This relational expression specifies the equivalent focal length of the optical imaging system for a full-frame sensor. Within the range specified by the relational expression, the golden focal length for shooting portraits can be satisfied.

A focal length of the fourth lens L4 is defined as f4, and a focal length of the fifth lens L5 is defined as f5, and the following relational expression is satisfied: −1.05≤f4/f5≤−0.4. This relational expression specifies the ratio of the focal length of the fourth lens L4 to the focal length of the fifth lens L5. The optical system has better imaging quality and lower sensitivity by reasonably allocating the optical focal length of the optical system. Optionally, −1.03≤f4/f5≤−0.4.

An object side surface of the first lens L1 is convex in a paraxial region, and an image side surface of the first lens L1 is concave or convex in the paraxial region. The first lens L1 has a positive refractive power. The object side surface of the first lens L1 may also be configured with other concave and convex arrangements.

The focal length of the camera optical lens 10, 20, 30 and 40 is defined as f, and the focal length of the first lens L1 is defined as f1, and the following relational expression is satisfied: 0.44≤f1/f≤0.49. The aberrations of the optical system can be effectively corrected by controlling the positive refractive power of the first lens L1 within a reasonable range, so as to improve the imaging quality.

A central curvature radius of the object side surface of the first lens L1 is defined as R1, and a central curvature radius of the image side surface of the first lens L1 is defined as R2, and the following relational expression is satisfied: −1.04≤(R1+R2)/(R1−R2)≤−0.77. This relational expression specifies the ratio of the sum of the central curvature radius R1 of the object side surface of the first lens L1 and the central curvature radius R2 of the image side surface of the first lens L1 to the difference between the central curvature radius R1 of the object side surface of the first lens L1 and the central curvature radius R2 of the image side surface of the first lens L1, and thus specifies the shape of the first lens L1. Within the range specified by the relational expression, the first lens L1 can effectively correct a spherical aberration of the system.

An on-axis thickness of the first lens L1 is d1, and the total track length of the camera optical lens 10, 20, 30 and 40 is TTL, and the following relational expression is satisfied: 0.145≤d1/TTL≤0.244. Within the range of the relational expression, it is beneficial to achieve ultra-thin property.

An object side surface of the second lens L2 is convex in the paraxial region, and an image side surface of the second lens L2 is concave in the paraxial region. The second lens L2 has a positive refractive power. The object side surface and the image side surface of the second lens L2 may also be configured with other concave and convex arrangements.

The focal length of the camera optical lens 10, 20, 30 and 40 is defined as f, and a focal length of the second lens L2 is defined as f2, and the following relational expression is satisfied: −1.43≤f2/f≤−0.65. This relational expression specifies the ratio of the focal length of the second lens L2 to the focal length of the camera optical lens 10, 20, 30, and 40. Controlling the positive refractive power of the second lens L2 within a reasonable range is conducive to correcting the aberrations of the optical system.

A central curvature radius of the object side surface of the second lens L2 is R3, and a central curvature radius of the image side surface of the second lens L2 is R4, and the following relational expression is satisfied: 1.53≤(R3+R4)/(R3−R4)≤2.82. This relational expression specifies the ratio of the sum of the central curvature radius R3 of the object side surface of the second lens L2 and the central curvature radius R4 of the image side surface of the second lens L2 to the difference between the central curvature radius R3 of the object side surface of the second lens L2 and the central curvature radius R4 of the image side surface of the second lens L2, and thus specifies the shape of the second lens L2. Within the range specified by the relational expression, it is conducive to correcting the on-axis chromatic aberrations, improving the image clarity, and reducing the image color distortion, so as to improve the imaging quality.

An on-axis thickness of the second lens L2 is d3, and the total track length of the camera optical lens 10, 20, 30 and 40 is TTL, and the following relational expression is satisfied: 0.026≤d3/TTL≤0.033. Within the range of relational expression, it is beneficial to achieve ultra-thin property.

An object side surface of the third lens L3 is convex or concave in a paraxial region, and an image side surface of the third lens L3 is concave in the paraxial region. The third lens L3 has a negative refractive power. The image side surface of the third lens L3 may also be configured with other concave and convex arrangements.

The focal length of the camera optical lens 10, 20, 30 and 40 is defined as f, and a focal length of the third lens L3 is defined as f3, and the following relational expression is satisfied: −1.20≤f3/f≤−0.83. This relational expression specifies the ratio of the focal length of the third lens L3 to the focal length of the camera optical lens 10, 20, 30, and 40. Within the specified range of the relational expression, the imaging quality of the system can be improved, and the sensitivity of the system can be reduced.

A central curvature radius of the object side surface of the third lens L3 is R5, and a central curvature radius of the image side surface of the third lens L3 is R6, and the following relational expression is satisfied: 0.73≤(R5+R6)/(R5−R6)≤1.80. This relational expression specifies the ratio of the sum of the central curvature radius R5 of the object side surface of the third lens L3 and the central curvature radius R6 of the image side surface of the third lens L3 to the difference between the central curvature radius R5 of the object side surface of the third lens L3 and the central curvature radius R6 of the image side surface of the third lens L3, and thus specifies the shape of the third lens L3. Within the range specified by the relational expression, the degree of deflection of light passing through the lens can be reduced, thereby reducing aberrations, and improving the imaging quality of the ultra-thin wide-angle lens.

An on-axis thickness of the third lens L3 is d5, and the total track length of the camera optical lens 10, 20, 30 and 40 is TTL, the following relational expression is satisfied: 0.028≤d5/TTL≤0.039. Within the range of relational expression, it is beneficial to achieve ultra-thin property.

An object side surface of the fourth lens L4 is concave in a paraxial region, and an image side surface of the fourth lens L4 is convex in the paraxial region. The fourth lens L4 has a positive refractive power. The object side surface and the image side surface of the fourth lens L4 may also be configured with other concave and convex arrangements.

The focal length of the camera optical lens 10, 20, 30 and 40 is defined as f, and a focal length of the fourth lens L4 is defined as f4, and the following relational expression is satisfied: −0.76≤f4/f≤−0.32, which specifies the ratio of the focal length of the fourth lens L4 to the focal length of the camera optical lens 10, 20, 30, and 40. Within the range specified by the relational expression, the light angle of the camera optical lens can be effectively smooth, thereby reducing the tolerance sensitivity.

A central curvature radius of the object side surface of the fourth lens L4 is R7, and a central curvature radius of the image side surface of the fourth lens L4 is R8, and the following relational expression is satisfied: −1.37≤(R7+R8)/(R7−R8)≤−1.05. This relational expression specifies the ratio of the sum of the central curvature radius R7 of the object side surface of the fourth lens L4 and the central curvature radius R8 of the image side surface of the fourth lens L4 to the difference of the central curvature radius R7 of the object side surface of the fourth lens L4 and the central curvature radius R8 of the image side surface of the fourth lens L4, and thus specifies the shape of the fourth lens L4. Within the range specified by the relational expression, it is conducive to correcting the on-axis chromatic aberrations, improving the image clarity, and reducing the image color distortion, so as to improve the imaging quality.

An on-axis thickness of the fourth lens L4 is d7, and the total track length of the camera optical lens 10, 20, 30 and 40 is TTL, the following relational expression is satisfied: 0.026≤d7/TTL≤0.038. Within the range of relational expression, it is beneficial to achieve ultra-thin.

An object side surface of the fifth lens L5 is concave or convex in a paraxial region, and an image side surface of the fifth lens L5 is convex in the paraxial region. The fifth lens L5 has a negative refractive power. The image side surface of the fifth lens L5 may also be configured with other concave and convex arrangements.

The focal length of the camera optical lens 10, 20, 30 and 40 is defined as f, and a focal length of the fifth lens L5 is defined as f5, and the following relational expression is satisfied: 0.31≤f5/f≤1.90, which specifies the ratio of the focal length of the fifth lens L5 to the focal lengths of the camera optical lens 10, 20, 30, and 40. Within the range specified by the relational expression, it is helpful to improve the performance of the optical system.

A central curvature radius of the object side surface of the fifth lens L5 is R9, and a central curvature radius of the image side surface of the fifth lens L5 is R10, and the following relational expression is satisfied: −0.34≤(R9+R10)/(R9−R10)≤1.98. This relational expression specifies the ratio of the sum of the central curvature radius R9 of the object side surface of the fifth lens L5 and the central curvature radius R10 of the image side surface of the fifth lens L5 to the difference of the central curvature radius R9 of the object side surface of the fifth lens L5 and the central curvature radius R10 of the image side surface of the fifth lens L5, and thus specifies the shape of the fifth lens L5. Within the range specified by the relational expression, it is conducive to correcting the on-axis chromatic aberrations, improving the image clarity, and reducing the image color distortion, so as to improve the imaging quality.

An on-axis thickness of the fifth lens L5 is d9, and the total track length of the camera optical lens 10, 20, 30 and 40 is TTL, the following relational expression is satisfied: 0.111≤d9/TTL≤0.163. Within the range of relational expression, it is beneficial to achieve ultra-thin property.

The first lens L1 is made of glass or plastic, the second lens L2 is made of plastic, the third lens L3 is made of plastic, the fourth lens L4 is made of plastic, and the fifth lens L5 is made of plastic. Each lens may also be made of other materials.

The image height at a 1.0 field of view of the camera optical lens 10, 20, 30 and 40 is IH, and the total track length of the camera optical lens 10 is TTL, and the following relational expression is satisfied: TTL/IH≤3.96, which is beneficial to achieving ultra-thin. Optionally, TTL/IH≤3.17.

A field of view FOV at the 1.0 field of view of the camera optical lens 10, 20, 30 and 40 is greater than or equal to 32.29°, thereby achieving wide-angle property.

An f-number FNO of the camera optical lens 10, 20, 30 and 40 is less than or equal to 2.57, so as to achieve a large aperture, and good imaging performance of the camera optical lens. Optionally, the f-number FNO of the camera optical lens 10, 20, 30 and 40 is less than or equal to 2.52.

The camera optical lens of the present disclosure will be described below with examples. The reference signs recited in each example are shown below. The units of the focal length, the on-axis distance, the central curvature radius, the on-axis thickness, the inflection point position, and the arrest point position are mm.

TTL: a total track length (an on-axis distance from the object side surface of the first lens L1 to the image plane Si), in mm.

F-number FNO: a ratio of the effective focal length of the camera optical lens to the entrance pupil diameter.

Image height IH at 1.0 field of view: a height of the field of view corresponding to the active pixel of the sensor (that is, half of the diagonal length of the active pixel area of the sensor).

Field of view FOV at 1.0 field of view: a field of view corresponding to the active pixel of the sensor.

Image height IHm at MIC field of view: a height of the field of view expanding beyond 1.0 field of view for preventing assembly deviation.

Field of view FOVm at MIC field of view: a field of view corresponding to an image height at MIC field of view.

Optionally, the object side surface and/or the image side surface of the lens may also be provided with an inflection point and/or an arrest point, so as to meet high-quality imaging requirements.

The technical solutions of the present disclosure will be described in detail in four embodiments.

### First Embodiment

The first lens L1 has a positive refractive power and is made of glass. An object side surface of the first lens L1 is convex in the paraxial region, and an image side surface of the first lens L1 is convex in the paraxial region.

The second lens L2 has a negative refractive power and is made of a plastic. An object side surface of the second lens L2 is convex in the paraxial region, and an image side surface of the second lens L2 is concave in the paraxial region.

The third lens L3 has a negative refractive power and is made of a plastic. An object side surface of the third lens L3 is convex in the paraxial region, and an image side surface of the third lens L3 is concave in the paraxial region.

The fourth lens L4 has a negative refractive power and is made of a plastic. An object side surface of the fourth lens L4 is concave in the paraxial region, and an image side surface of the fourth lens L4 is convex in the paraxial region.

The fifth lens L5 has a positive refractive power and is made of a plastic. An object side surface of the fifth lens L5 is convex in the paraxial region, and an image side surface of the fifth lens L5 is convex in the paraxial region.

Table 1 shows design data of the camera optical lens 10 according to the first embodiment of the present disclosure.

TABLE 1

| | R | d | | nd | | vd | |
|---|---|---|---|---|---|---|---|
| S1 | ∞ | d0 = | −0.695 | | | | |
| R1 | 1.806 | d1 = | 1.028 | nd1 | 1.4959 | v1 | 81.64 |
| R2 | −36.094 | d2 = | 0.699 | | | | |
| R3 | 7.975 | d3 = | 0.200 | nd2 | 1.6856 | v2 | 18.40 |
| R4 | 3.027 | d4 = | 0.454 | | | | |
| R5 | 59.776 | d5 = | 0.200 | nd3 | 1.5444 | v3 | 55.82 |
| R6 | 3.940 | d6 = | 1.699 | | | | |
| R7 | −2.303 | d7 = | 0.230 | nd4 | 1.5444 | v4 | 55.82 |
| R8 | −30.290 | d8 = | 0.090 | | | | |
| R9 | 13.742 | d9 = | 0.690 | nd5 | 1.6700 | v5 | 19.39 |
| R10 | −5.356 | d10 = | 0.910 | | | | |
| R11 | ∞ | d11 = | 0.110 | ndg | 1.5168 | vg | 64.17 |
| R12 | ∞ | d12 = | 0.454 | | | | |

The meaning of each reference sign is as follows:
S1: aperture;
R: central curvature radius at the center of the optical surface;
R1: central curvature radius of the object side surface of the first lens L1;
R2: central curvature radius of the image side surface of the first lens L1;
R3: central curvature radius of the object side surface of the second lens L2;
R4: central curvature radius of the image side surface of the second lens L2;
R5: central curvature radius of the object side surface of the third lens L3;
R6: central curvature radius of the image side surface of the third lens L3;
R7: central curvature radius of the object side surface of the fourth lens L4;
R8: central curvature radius of the image side surface of the fourth lens L4;
R9: central curvature radius of the object side surface of the fifth lens L5;
R10: central curvature radius of the image side surface of the fifth lens L5;
R11: central curvature radius of the object side surface of the grating filter GF;
R12: central curvature radius of the image side surface of the grating filter GF;
d: on-axis thickness of the lens or on-axis distance between the lenses;
d0: on-axis distance from the aperture S1 to the object side surface of the first lens L1;
d1: on-axis thickness of the first lens L1;
d2: on-axis distance from the image side surface of the first lens L1 to the object side surface of the second lens L2;
d3: on-axis thickness of the second lens L2;
d4: on-axis distance from the image side surface of the second lens L2 to the object side surface of the third lens L3;
d5: on-axis thickness of the third lens L3;
d6: on-axis distance from the image side surface of the third lens L3 to the object side surface of the fourth lens L4;
d7: on-axis thickness of the fourth lens L4;
d8: on-axis distance from the image side surface of the fourth lens L4 to the object side surface of the fifth lens L5;
d9: on-axis thickness of the fifth lens L5;
d10: on-axis distance from the image side surface of the fifth lens L5 to the object side surface of the sixth lens L6;
d11: on-axis thickness of the grating filter GF;
d12: on-axis distance from the image side surface of the grating filter GF to the image plane Si;
nd: refractive index of d line (the d line is green light with a wavelength of 550 nm);
nd1: refractive index of d line of the first lens L1;
nd2: refractive index of d line of the second lens L2;
nd3: refractive index of d line of the third lens L3;
nd4: refractive index of d line of the fourth lens L4;
nd5: refractive index of d line of the fifth lens L5;
ndg: refractive index of d line of the grating filter GF;
vd: abbe number;
v1: abbe number of the first lens L1;
v2: abbe number of the second lens L2;
v3: abbe number of the third lens L3;
v4: abbe number of the fourth lens L4;
v5: abbe number of the fifth lens L5;
vg: Abbe number of the grating filter GF.

Table 2 shows aspheric data of each lens in the camera optical lens 10 according to the first embodiment of the present disclosure.

TABLE 2

| | Conic Coefficient | Aspheric Coefficient | | | | |
|---|---|---|---|---|---|---|
| | k | A4 | A6 | A8 | A10 | A12 |
| R1 | −3.4483E−01 | 3.2135E−03 | −1.8631E−02 | 1.2423E−01 | −4.7792E−01 | 1.1795E+00 |
| R2 | 9.2856E+01 | 5.6247E−03 | 3.7135E−02 | −2.0778E−01 | 7.0192E−01 | −1.5867E+00 |
| R3 | 5.7473E+01 | −2.5586E−02 | 4.3152E−01 | −4.2559E+00 | 3.7676E+01 | −2.2638E+02 |
| R4 | 1.0462E+00 | −6.4514E−02 | 1.5561E+00 | −2.4045E+01 | 2.7453E+02 | −2.0904E+03 |
| R5 | 7.3165E+01 | −1.6087E−02 | 3.0121E−01 | −1.3059E+00 | 1.8602E+01 | −1.5424E+02 |
| R6 | 1.4979E+01 | 1.8740E−02 | 1.0477E+00 | −1.5354E+01 | 1.6543E+02 | −1.1736E+03 |
| R7 | −1.3801E+01 | −1.7947E−01 | 4.8205E−01 | −8.8796E−01 | 3.9210E−01 | 1.9850E+00 |
| R8 | 5.5582E+00 | −6.0870E−02 | 5.2837E−02 | 2.5328E−01 | −1.2838E+00 | 2.7781E+00 |
| R9 | 2.7524E+01 | −3.6551E−02 | −3.5634E−02 | −5.8612E−02 | 5.2781E−01 | −1.1508E+00 |
| R10 | 4.1814E+00 | −2.5944E−02 | 3.7231E−02 | −1.2031E−01 | 6.2009E−02 | 3.1589E−01 |
| | k | A14 | A16 | A18 | A20 | A22 |
| R1 | −3.4483E−01 | −1.9822E+00 | 2.3477E+00 | −1.9948E+00 | 1.2217E+00 | −5.3484E−01 |
| R2 | 9.2856E+01 | 2.5051E+00 | −2.8325E+00 | 2.3207E+00 | −1.3785E+00 | 5.8665E−01 |
| R3 | 5.7473E+01 | 9.4672E+02 | −2.8264E+03 | 6.1022E+03 | −9.5427E+03 | 1.0694E+04 |
| R4 | 1.0462E+00 | 1.1061E+04 | −4.1716E+04 | 1.1356E+05 | −2.2345E+05 | 3.1447E+05 |
| R5 | 7.3165E+01 | 8.0775E+02 | −2.8916E+03 | 7.3242E+03 | −1.3270E+04 | 1.7098E+04 |
| R6 | 1.4979E+01 | 5.7185E+03 | −1.9751E+04 | 4.9139E+04 | −8.8353E+04 | 1.1375E+05 |
| R7 | −1.3801E+01 | −5.1445E+00 | 6.5267E+00 | −5.2391E+00 | 2.8424E+00 | −1.0592E+00 |
| R8 | 5.5582E+00 | −3.6489E+00 | 3.2452E+00 | −2.0576E+00 | 9.4880E−01 | −3.1690E−01 |
| R9 | 2.7524E+01 | 1.3850E+00 | −1.0527E+00 | 5.2509E−01 | −1.7184E−01 | 3.5448E−02 |
| R10 | 4.1814E+00 | −7.3311E−01 | 7.9399E−01 | −5.2719E−01 | 2.3149E−01 | −6.8748E−02 |
| | k | A24 | A26 | A28 | A30 | |
| R1 | −3.4483E−01 | 1.6326E−01 | −3.3015E−02 | 3.9758E−03 | −2.1597E−04 | |
| R2 | 9.2856E+01 | −1.7397E−01 | 3.4057E−02 | −3.9444E−03 | 2.0403E−04 | |
| R3 | 5.7473E+01 | −8.3637E+03 | 4.3300E+03 | −1.3322E+03 | 1.8426E+02 | |
| R4 | 1.0462E+00 | −3.0823E+05 | 1.9961E+05 | −7.6673E+04 | 1.3213E+04 | |
| R5 | 7.3165E+01 | −1.5308E+04 | 9.0564E+03 | −3.1856E+03 | 5.0485E+02 | |
| R6 | 1.4979E+01 | −1.0223E+05 | 6.0898E+04 | −2.1604E+04 | 3.4548E+03 | |
| R7 | −1.3801E+01 | 2.6773E−01 | −4.3916E−02 | 4.2203E−03 | −1.8045E−04 | |
| R8 | 5.5582E+00 | 7.4633E−02 | −1.1719E−02 | 1.0972E−03 | −4.6185E−05 | |
| R9 | 2.7524E+01 | −4.0406E−03 | 1.2225E−04 | 2.1947E−05 | −1.8241E−06 | |
| R10 | 4.1814E+00 | 1.3695E−02 | −1.7559E−03 | 1.3108E−04 | −4.3328E−06 | |

For convenience, the aspheric of each lens surface uses the aspheric shown in the following formula (1). However, the present disclosure is not limited to the aspheric polynomial form represented by formula (1).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} , \qquad ( 1 )$$

where k represents a conic coefficient, A4, A6, A8, A10, A12, A14, A16, A18, A20, A22, A24, A26, A28 and A30 represent aspheric coefficients, c represents a curvature at the center of the optical surface, r represents a vertical distance between a point on the aspheric curve and the optical axis, and z represents a depth of the aspheric (a vertical distance between a point on the aspheric at a distance r from the optical axis and a tangent plane tangent to a vertex on the aspheric optical axis).

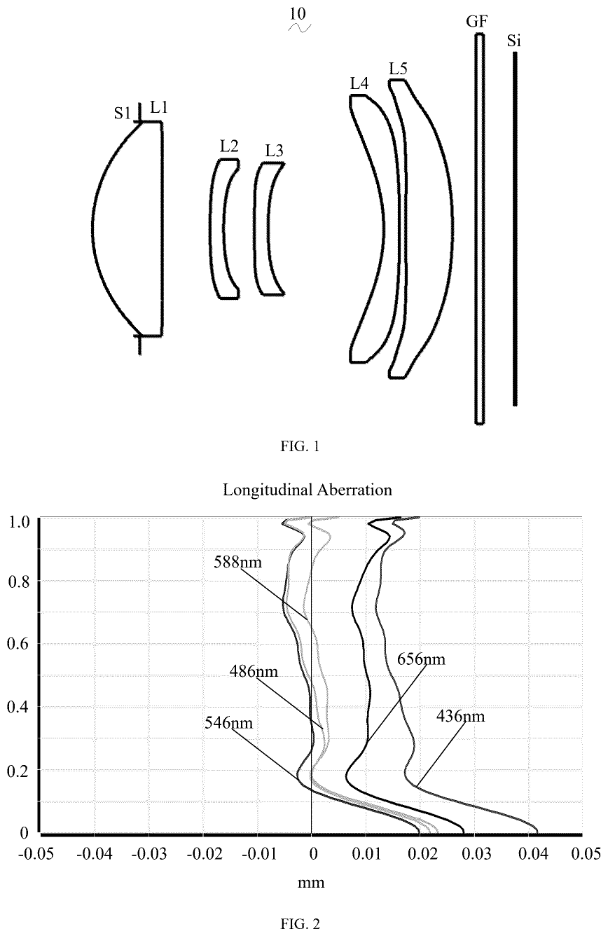

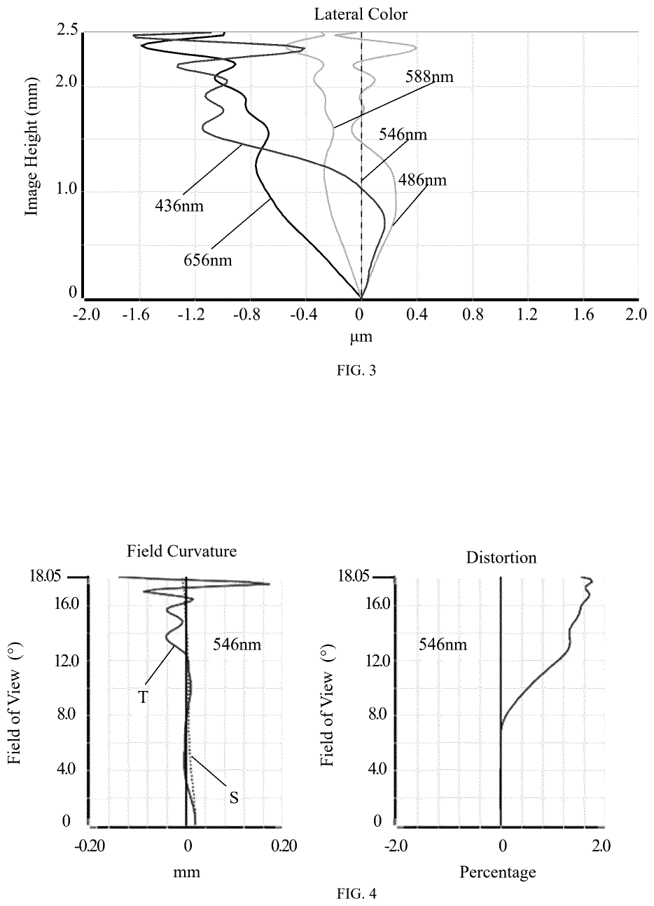

FIG. 2 and FIG. 3 respectively show a longitudinal aberration and a lateral color of light at wavelengths of 656 nm, 587 nm, 546 nm, 486 nm, and 436 nm after passing the camera optical lens 10 according to the first embodiment. FIG. 4 shows a schematic diagram of the field curvature and the distortion of the light at a wavelength of 546 nm after passing through the camera optical lens 10 according to the first embodiment. The field curvature S in FIG. 4 is a field curvature in a sagittal direction, and T is a field curvature in a meridian direction.

In this embodiment, the entrance pupil diameter ENPD of the camera optical lens 10 is 3.038 mm, the image height IH at the 1.0 field of view is 2.500 mm, the field of view FOV at the 1.0 field of view is 36.10°, the image height IHm at the MIC field of view is 2.650 mm, and the field of view FOVm at the MIC field of view is 38.36°. The camera optical lens 10 meets the design requirements of large aperture, wide-angle and ultra-thin, effectively correcting both the on-axis and off-axis chromatic aberrations thereof, and has excellent optical characteristics.

### Second Embodiment

The meaning of the reference signs of the second embodiment is the same as that of the first embodiment.

Different from the first embodiment, in this embodiment, the object side surface of the third lens L3 is concave in the paraxial region, and the object side surface of the fifth lens L5 is concave in the paraxial region.

FIG. 5 shows a camera optical lens 20 according to the second embodiment of the present disclosure.

Table 3 shows design data of the camera optical lens 20 according to the second embodiment of the present disclosure.

TABLE 3

| | R | d | | nd | | vd | |
|---|---|---|---|---|---|---|---|
| S1 | ∞ | d0 = | −0.649 | | | | |
| R1 | 1.902 | d1 = | 1.551 | nd1 | 1.4959 | v1 | 81.64 |
| R2 | −14.989 | d2 = | 0.227 | | | | |
| R3 | 8.061 | d3 = | 0.182 | nd2 | 1.6856 | v2 | 18.40 |
| R4 | 3.841 | d4 = | 0.566 | | | | |
| R5 | −26.440 | d5 = | 0.248 | nd3 | 1.5444 | v3 | 55.82 |
| R6 | 3.971 | d6 = | 2.102 | | | | |
| R7 | −2.642 | d7 = | 0.180 | nd4 | 1.5444 | v4 | 55.82 |
| R8 | −17.010 | d8 = | 0.099 | | | | |
| R9 | −20.571 | d9 = | 0.887 | nd5 | 1.6700 | v5 | 19.39 |
| R10 | −6.727 | d10 = | 0.318 | | | | |
| R11 | ∞ | d11 = | 0.110 | ndg | 1.5168 | vg | 64.17 |
| R12 | ∞ | d12 = | 0.102 | | | | |

Table 4 shows aspheric data of each lens in the camera optical lens 20 according to the second embodiment of the present disclosure.

TABLE 4

| | Conic Coefficient | Aspheric Coefficient | | | | |
|---|---|---|---|---|---|---|
| | k | A4 | A6 | A8 | A10 | A12 |
| R1 | −3.4068E−01 | 3.3337E−03 | −9.2823E−03 | 5.0095E−02 | −1.7692E−01 | 4.1771E−01 |
| R2 | −4.2280E+01 | 1.2406E−02 | 1.1624E−01 | −9.8965E−01 | 4.9484E+00 | −1.6451E+01 |
| R3 | 5.4763E+01 | −4.2310E−03 | 4.3152E−01 | −3.4655E+00 | 2.0711E+01 | −7.9116E+01 |
| R4 | 1.1498E+00 | 1.5570E−02 | 4.6299E−01 | −3.6935E+00 | 2.6771E+01 | −1.2663E+02 |
| R5 | −8.8427E+01 | 1.5234E−01 | −1.0542E−01 | 1.2939E+00 | −7.2058E+00 | 2.0891E+01 |
| R6 | 1.5144E+01 | 1.3657E−01 | 5.1514E−01 | −8.3235E+00 | 8.0902E+01 | −5.2214E+02 |
| R7 | −9.2113E+00 | 3.4628E−01 | −2.1614E+00 | 5.7863E+00 | −8.6332E+00 | 6.4035E+00 |
| R8 | 1.9936E+01 | 1.1012E+00 | −5.0965E+00 | 1.2759E+01 | −2.0590E+01 | 2.3023E+01 |
| R9 | 5.5570E+01 | 5.4083E−01 | −2.2213E+00 | 4.6977E+00 | −6.2626E+00 | 5.6414E+00 |
| R10 | 6.2441E+00 | −1.7827E−01 | 1.7873E−01 | −1.6292E−01 | 1.8455E−01 | −2.3247E−01 |
| | k | A14 | A16 | A18 | A20 | A22 |
| R1 | −3.4068E−01 | −6.8117E−01 | 7.8428E−01 | −6.4587E−01 | 3.8144E−01 | −1.6007E−01 |
| R2 | −4.2280E+01 | 3.8059E+01 | −6.2902E+01 | 7.5238E+01 | −6.5239E+01 | 4.0588E+01 |
| R3 | 5.4763E+01 | 1.9211E+02 | −2.7144E+02 | 1.1272E+02 | 3.5650E+02 | −8.2438E+02 |
| R4 | 1.1498E+00 | 4.0478E+02 | −8.8117E+02 | 1.2799E+03 | −1.1429E+03 | 4.3400E+02 |
| R5 | −8.8427E+01 | −1.3291E+01 | −1.3302E+02 | 5.7848E+02 | −1.2591E+03 | 1.7178E+03 |
| R6 | 1.5144E+01 | 2.3212E+03 | −7.2977E+03 | 1.6450E+04\| | −2.6645E+04 | 3.0698E+04 |
| R7 | −9.2113E+00 | 5.9852E−01 | −6.5477E+00 | 7.3652E+00 | −4.6650E+00 | 1.9129E+00 |
| R8 | 1.9936E+01 | −1.8559E+01 | 1.1024E+01 | −4.8711E+00 | 1.5985E+00 | −3.8429E−01 |
| R9 | 5.5570E+01 | −3.5359E+00 | 1.5524E+00 | −4.7083E−01 | 9.4128E−02 | −1.0767E−02 |
| R10 | 6.2441E+00 | 2.3251E−01 | −1.6129E−01 | 7.6263E−02 | −2.4707E−02 | 5.4741E−03 |
| | k | A24 | A26 | A28 | A30 | |
| R1 | −3.4068E−01 | 4.6535E−02 | −8.9007E−03 | 1.0063E−03 | −5.0893E−05 | |
| R2 | −4.2280E+01 | −1.7647E+01 | 5.0883E+00 | −8.7360E−01 | 6.7560E−02 | |
| R3 | 5.4763E+01 | 8.7764E+02 | −5.3727E+02 | 1.8240E+02 | −2.6760E+01 | |
| R4 | 1.1498E+00 | 2.3904E+02 | −3.8104E+02 | 1.8295E+02 | −3.2330E+01 | |
| R5 | −8.8427E+01 | −1.5264E+03 | 8.6147E+02 | −2.8129E+02 | 4.0540E+01 | |
| R6 | 1.5144E+01 | −2.4500E+04 | 1.2845E+04 | −3.9683E+03 | 5.4547E+02 | |
| R7 | −9.2113E+00 | −5.1892E−01 | 9.0259E−02 | −9.1390E−03 | 4.1013E−04 | |
| R8 | 1.9936E+01 | 6.5705E−02 | −7.5557E−03 | 5.2307E−04 | −1.6443E−05 | |
| R9 | 5.5570E+01 | 2.6633E−04 | 1.0217E−04 | −1.3379E−05 | 5.4502E−07 | |
| R10 | 6.2441E+00 | −8.1356E−04 | 7.7314E−05 | −4.2279E−06 | 1.0064E−07 | |

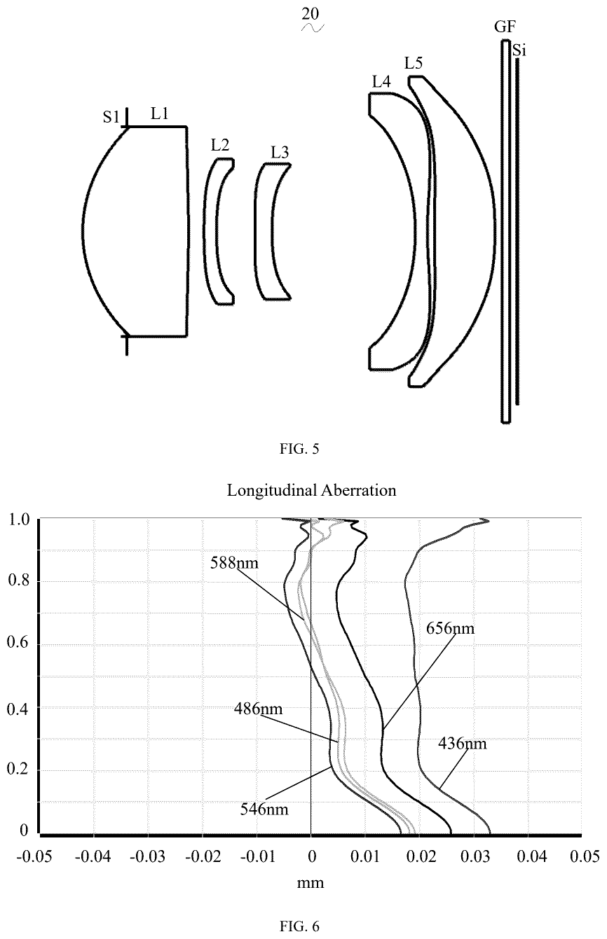

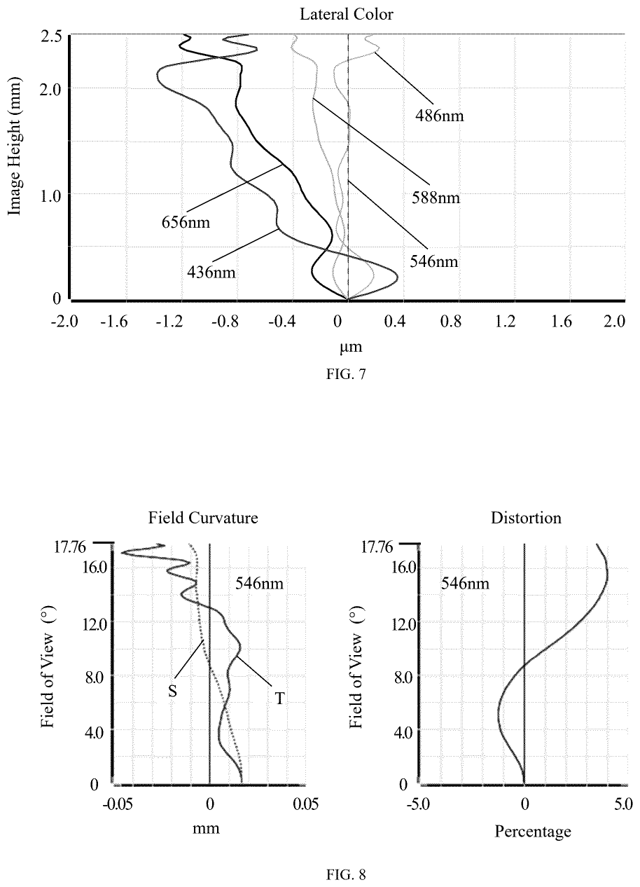

FIG. 6 and FIG. 7 respectively show a longitudinal aberration and a lateral color of the light at wavelengths of 656 nm, 587 nm, 546 nm, 486 nm, and 436 nm after passing the camera optical lens 20 according to the second embodiment. FIG. 8 shows a schematic diagram of the field curvature and the distortion of the light at a wavelength of 546 nm after passing through the camera optical lens 20 according to the second embodiment. The field curvature S in FIG. 8 is a field curvature in a sagittal direction, and T is a field curvature in a meridian direction.

In this embodiment, the entrance pupil diameter ENPD of the camera optical lens 20 is 3.035 mm, the image height IH at the 1.0 field of view is 2.500 mm, the field of view FOV at the 1.0 field of view is 35.53°, the image height IHm at the MIC field of view is 2.650 mm, and the field of view FOVm at the MIC field of view is 37.77°. The camera optical lens 20 meets the design requirements of large aperture, wide-angle and ultra-thin, effectively correcting both the on-axis and off-axis chromatic aberrations thereof, and has excellent optical characteristics.

### Third Embodiment

The meaning of the reference signs of the third embodiment is the same as that of the first embodiment.

Different from the first embodiment, in this embodiment, the image side surface of the first lens L1 is concave in the paraxial region.

FIG. 9 shows a camera optical lens 30 according to the third embodiment of the present disclosure.

Table 5 shows design data of the camera optical lens 30 according to the third embodiment of the present disclosure.

TABLE 5

| | R | d | | nd | | vd | |
|---|---|---|---|---|---|---|---|
| S1 | ∞ | d0 = | −0.868 | | | | |
| R1 | 1.732 | d1 = | 1.077 | nd1 | 1.4959 | v1 | 81.64 |
| R2 | 95.845 | d2 = | 1.000 | | | | |
| R3 | 8.720 | d3 = | 0.164 | nd2 | 1.6856 | v2 | 18.40 |
| R4 | 2.543 | d4 = | 0.320 | | | | |
| R5 | 12.097 | d5 = | 0.199 | nd3 | 1.5444 | v3 | 55.82 |
| R6 | 3.443 | d6 = | 1.493 | | | | |
| R7 | −2.242 | d7 = | 0.160 | nd4 | 1.5444 | v4 | 55.82 |
| R8 | −85.365 | d8 = | 0.322 | | | | |
| R9 | 9.431 | d9 = | 1.001 | nd5 | 1.6700 | v5 | 19.39 |
| R10 | −5.067 | d10 = | 0.407 | | | | |
| R11 | ∞ | d11 = | 0.110 | ndg | 1.5168 | vg | 64.17 |
| R12 | ∞ | d12 = | 0.146 | | | | |

Table 6 shows aspheric data of each lens in the camera optical lens 30 according to the third embodiment of the present disclosure.

TABLE 6

| | Conic Coefficient | Aspheric Coefficient | | | | |
|---|---|---|---|---|---|---|
| | k | A4 | A6 | A8 | A10 | A12 |
| R1 | −3.2059E−01 | −5.7629E−03 | 6.3114E−02 | −3.2116E−01 | 1.0386E+00 | −2.2588E+00 |
| R2 | −8.9896E+01 | 9.1102E−03 | −2.7572E−02 | 1.5708E−01 | −5.4736E−01 | 1.2420E+00 |
| R3 | 4.5784E+01 | 7.7109E−02 | −1.0519E+00 | 1.4148E+01 | −9.6780E+01 | 3.1468E+02 |
| R4 | 3.3888E+00 | −1.1187E−01 | 6.4234E+00 | −1.3995E+02 | 1.9538E+03 | −1.8102E+04 |
| R5 | 8.6704E+01 | −7.2208E−02 | 4.1609E+00 | −5.2482E+01 | 4.6311E+02 | −2.9100E+03 |
| R6 | 1.2353E+01 | −5.0435E−02 | 5.7289E+00 | −8.8135E+01 | 8.8545E+02 | −6.0920E+03 |
| R7 | −2.8053E+01 | 1.8401E−02 | −2.9162E−01 | 3.2409E−01 | 1.0302E−01 | −4.3356E−01 |
| R8 | 9.9900E+01 | 2.1271E−01 | −4.3183E−01 | 1.7946E−01 | 4.8074E−01 | −8.9164E−01 |
| R9 | 1.1450E+01 | −7.6053E−02 | 1.9372E−01 | −2.1818E−01 | 4.3772E−03 | 2.4971E−01 |
| R10 | 4.0834E+00 | 2.8774E−02 | −8.2351E−01 | 2.3820E+00 | −3.6786E+00 | 3.6159E+00 |
| | k | A14 | A16 | A18 | A20 | A22 |
| R1 | −3.2059E−01 | 3.4310E+00 | −3.7227E+00 | 2.9177E+00 | −1.6528E+00 | 6.6929E−01 |
| R2 | −8.9896E+01 | −1.9403E+00 | 2.1551E+00 | −1.7295E+00 | 1.0063E+00 | −4.2044E−01 |
| R3 | 4.5784E+01 | 2.2882E+02 | −6.9643E+03 | 3.3258E+04 | −8.9877E+04 | 1.5666E+05 |
| R4 | 3.3888E+00 | 1.1623E+05 | −5.3115E+05 | 1.7513E+06 | −4.1762E+06 | 7.1321E+06 |
| R5 | 8.6704E+01 | 1.3296E+04 | −4.4674E+04 | 1.1066E+05 | −2.0098E+05 | 2.6356E+05 |
| R6 | 1.2353E+01 | 2.9562E+04 | −1.0314E+05 | 2.6111E+05 | −4.7947E+05 | 6.3127E+05 |
| R7 | −2.8053E+01 | 1.3521E−01 | 4.3907E−01 | −6.5353E−01 | 4.6087E−01 | −1.9819E−01 |
| R8 | 9.9900E+01 | 6.6993E−01 | −1.8365E−01 | −9.5156E−02 | 1.1661E−01 | −5.5458E−02 |
| R9 | 1.1450E+01 | −3.1706E−01 | 2.1810E−01 | −9.7780E−02 | 3.0108E−02 | −6.4215E−03 |
| R10 | 4.0834E+00 | −2.4148E+00 | 1.1240E+00 | −3.6468E−01 | 8.0218E−02 | −1.1027E−02 |
| | k | A24 | A26 | A28 | A30 | |
| R1 | −3.2059E−01 | −1.8859E−01 | 3.5062E−02 | −3.8589E−03 | 1.8998E−04 | |
| R2 | −8.9896E+01 | 1.2290E−01 | −2.3849E−02 | 2.7576E−03 | −1.4368E−04 | |
| R3 | 4.5784E+01 | −1.7983E+05 | 1.3183E+05 | −5.6079E+04 | 1.0548E+04 | |
| R4 | 3.3888E+00 | −8.5006E+06 | 6.7121E+06 | −3.1538E+06 | 6.6734E+05 | |
| R5 | 8.6704E+01 | −2.4231E+05 | 1.4791E+05 | −5.3767E+04 | 8.8000E+03 | |
| R6 | 1.2353E+01 | −5.8012E+05 | 3.5298E+05 | −1.2769E+05 | 2.0774E+04 | |
| R7 | −2.8053E+01 | 5.4623E−02 | −9.4652E−03 | 9.4258E−04 | −4.1245E−05 | |
| R8 | 9.9900E+01 | 1.5408E−02 | −2.6033E−03 | 2.4873E−04 | −1.0332E−05 | |
| R9 | 1.1450E+01 | 9.2888E−04 | −8.6215E−05 | 4.5615E−06 | −1.0169E−07 | |
| R10 | 4.0834E+00 | 7.0622E−04 | 2.7570E−05 | −7.7155E−06 | 3.7775E−07 | |

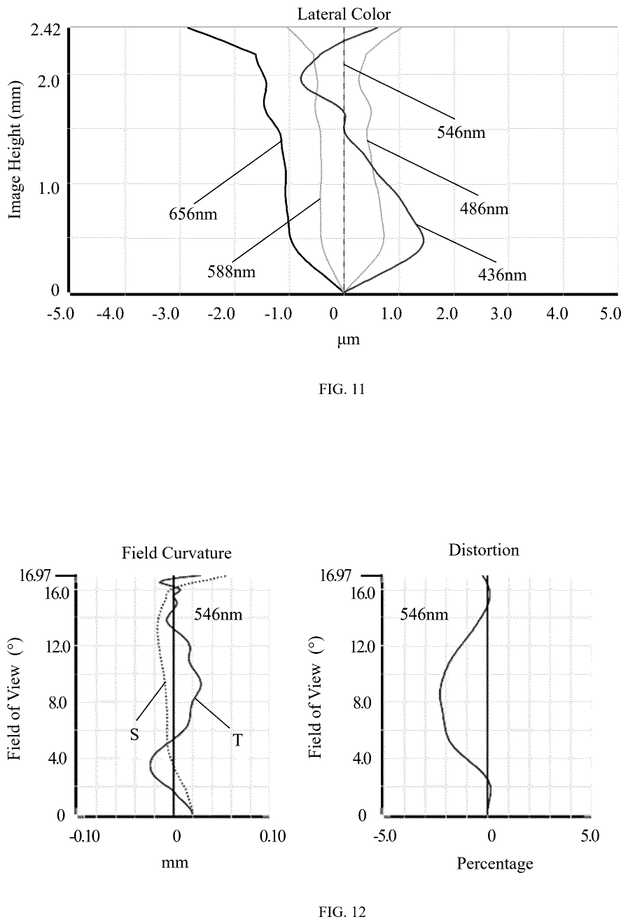

FIG. 10 and FIG. 11 respectively show a longitudinal aberration and a lateral color of the light at wavelengths of 656 nm, 587 nm, 546 nm, 486 nm, and 436 nm after passing through the camera optical lens 30 according to the third embodiment. FIG. 12 shows a schematic diagram of the field curvature and the distortion of the light at a wavelength of 546 nm after passing through the camera optical lens 30 according to the third embodiment. The field curvature S in FIG. 12 is a field curvature in a sagittal direction, and T is a field curvature in a meridional direction.

In this embodiment, the entrance pupil diameter ENPD of the camera optical lens 30 is 3.197 mm, the image height IH at the 1.0 field of view is 2.420 mm, the field of view FOV at the 1.0 field of view is 33.91°, the image height IHm at the MIC field of view is 2.570 mm, and the field of view FOVm at the MIC field of view is 36.18°. The camera optical lens 30 meets the design requirements of large aperture, wide-angle and ultra-thin, effectively correcting both the on-axis and off-axis chromatic aberrations thereof, and has excellent optical characteristics.

### Fourth Embodiment

The meaning of the reference signs of the fourth embodiment is the same as that of the first embodiment.

FIG. 9 shows a camera optical lens 40 according to the fourth embodiment of the present disclosure.

Table 7 shows design data of the camera optical lens 40 according to the fourth embodiment of the present disclosure.

TABLE 7

| | R | d | | nd | | vd | |
|---|---|---|---|---|---|---|---|
| S1 | ∞ | d0 = | −0.723 | | | | |
| R1 | 2.011 | d1 = | 0.963 | nd1 | 1.4959 | v1 | 81.64 |
| R2 | −34.865 | d2 = | 1.174 | | | | |
| R3 | 16.085 | d3 = | 0.189 | nd2 | 1.6856 | v2 | 18.40 |
| R4 | 3.370 | d4 = | 0.441 | | | | |
| R5 | 16.446 | d5 = | 0.190 | nd3 | 1.5444 | v3 | 55.82 |
| R6 | 3.934 | d6 = | 1.851 | | | | |
| R7 | −1.363 | d7 = | 0.196 | nd4 | 1.5444 | v4 | 55.82 |
| R8 | −52.339 | d8 = | 0.102 | | | | |
| R9 | 2.417 | d9 = | 0.849 | nd5 | 1.6700 | v5 | 19.39 |
| R10 | −4.885 | d10 = | 0.645 | | | | |
| R11 | ∞ | d11 = | 0.110 | ndg | 1.5168 | vg | 64.17 |
| R12 | ∞ | d12 = | 0.161 | | | | |

Table 8 shows aspheric data of each lens in the camera optical lens 40 according to the fourth embodiment of the present disclosure.

TABLE 8

| | Conic Coefficient | Aspheric Coefficient | | | | |
|---|---|---|---|---|---|---|
| | k | A4 | A6 | A8 | A10 | A12 |
| R1 | −3.0361E−01 | 1.1046E−03 | 1.3127E−02 | −8.8141E−02 | 3.2262E−01 | −7.5479E−01 |
| R2 | −4.3167E+00 | 1.6058E−02 | −5.9189E−02 | 2.6563E−01 | −8.0289E−01 | 1.6586E+00 |
| R3 | 9.4186E+01 | 3.7381E−02 | 2.7418E−01 | −3.2857E+00 | 2.2671E+01 | −9.6422E+01 |
| R4 | 2.5625E+00 | 2.6786E−03 | 1.0831E+00 | −1.4257E+01 | 1.2244E+02 | −6.8821E+02 |
| R5 | −4.4369E+01 | 3.2530E−02 | 1.7313E−01 | 3.4584E+00 | −5.6409E+01 | 4.4694E+02 |
| R6 | 1.3991E+01 | 1.4974E−01 | −1.4552E+00 | 2.2262E+01 | −2.0317E+02 | 1.2343E+03 |
| R7 | −1.6411E+01 | −3.7134E−01 | 1.2007E+00 | −2.1054E+00 | 2.2132E+00 | −1.4261E+00 |
| R8 | −9.9900E+01 | −3.1872E−01 | 4.3185E−01 | 7.1824E−01 | −2.7957E+00 | 3.8635E+00 |
| R9 | −4.4145E+01 | −1.5009E−01 | −2.5104E−02 | 5.3494E−01 | −8.3112E−01 | 6.7473E−01 |
| R10 | 3.5486E+00 | 4.5922E−02 | −4.9250E−01 | 1.5022E+00 | −2.9550E+00 | 4.0250E+00 |
| | k | A14 | A16 | A18 | A20 | A22 |
| R1 | −3.0361E−01 | 1.2037E+00 | −1.3498E+00 | 1.0804E+00 | −6.1931E−01 | 2.5193E−01 |
| R2 | −4.3167E+00 | −2.4054E+00 | 2.4951E+00 | −1.8695E+00 | 1.0121E+00 | −3.9144E−01 |
| R3 | 9.4186E+01 | 2.5197E+02 | −3.3495E+02 | −1.3202E+02 | 1.5042E+03 | −3.1206E+03 |
| R4 | 2.5625E+00 | 2.6000E+03 | −6.5467E+03 | 1.0299E+04 | −7.5083E+03 | −5.0998E+03 |
| R5 | −4.4369E+01 | −2.2288E+03 | 7.5420E+03 | −1.7879E+04 | 3.0030E+04 | −3.5571E+04 |
| R6 | 1.3991E+01 | −5.2261E+03 | 1.5799E+04 | −3.4495E+04 | 5.4431E+04 | −6.1389E+04 |
| R7 | −1.6411E+01 | 5.3850E−01 | −9.7450E−02 | 3.1006E−03 | −4.4294E−03 | 4.9877E−03 |
| R8 | −9.9900E+01 | −3.1077E+00 | 1.6258E+00 | −5.7371E−01 | 1.3647E−01 | −2.1039E−02 |
| R9 | −4.4145E+01 | −4.3299E−01 | 3.0315E−01 | −2.0014E−01 | 9.6801E−02 | −3.1426E−02 |
| R10 | 3.5486E+00 | −3.8027E+00 | 2.5053E+00 | −1.1605E+00 | 3.7929E−01 | −8.6890E−02 |
| | k | A24 | A26 | A28 | A30 | |
| R1 | −3.0361E−01 | −7.0920E−02 | 1.3120E−02 | −1.4331E−03 | 6.9942E−05 | |
| R2 | −4.3167E+00 | 1.0530E−01 | −1.8687E−02 | 1.9636E−03 | −9.2396E−05 | |
| R3 | 9.4186E+01 | 3.5622E+03 | −2.4315E+03 | 9.3283E+02 | −1.5542E+02 | |
| R4 | 2.5625E+00 | 1.8549E+04 | −1.9847E+04 | 1.0346E+04 | −2.2140E+03 | |
| R5 | −4.4369E+01 | 2.9055E+04 | −1.5574E+04 | 4.9294E+03 | −6.9822E+02 | |
| R6 | 1.3991E+01 | 4.8178E+04 | −2.4956E+04 | 7.6604E+03 | −1.0539E+03 | |
| R7 | −1.6411E+01 | −1.8878E−03 | 3.5988E−04 | −3.5410E−05 | 1.4390E−06 | |
| R8 | −9.9900E+01 | 1.8633E−03 | −5.4268E−05 | −4.5724E−06 | 3.2693E−07 | |
| R9 | −4.4145E+01 | 6.6585E−03 | −8.8482E−04 | 6.7047E−05 | −2.2132E−06 | |
| R10 | 3.5486E+00 | 1.3644E−02 | −1.3983E−03 | 8.4226E−05 | −2.2612E−06 | |

FIG. 10 and FIG. 11 respectively show a longitudinal aberration and a lateral color of the light at wavelengths of 656 nm, 587 nm, 546 nm, 486 nm, and 436 nm after passing the camera optical lens 40 according to the fourth embodiment. FIG. 12 shows a schematic diagram of the field curvature and the distortion of the light at a wavelength of 546 nm after passing through the camera optical lens 40 according to the fourth embodiment. The field curvature S in FIG. 12 is a field curvature in a sagittal direction, and T is a field curvature in a meridional direction.

In this embodiment, the entrance pupil diameter ENPD of the camera optical lens 40 is 3.197 mm, the image height IH at the 1.0 field of view is 2.500 mm, the field of view FOV at the 1.0 field of view is 32.29°, the image height IHm at the MIC field of view is 2.590 mm, and the field of view FOVm at the MIC field of view is 33.47°. The camera optical lens 40 meets the design requirements of large aperture, wide-angle and ultra-thin, effectively correcting both the on-axis and off-axis chromatic aberrations thereof, and has excellent optical characteristics.

Table 9 shows values of various values in the first, second, third and fourth embodiments corresponding to parameters specified in the relational expressions.

TABLE 9

| Parameters and Relational | | | | |
|---|---|---|---|---|
| expression | Embodiment 1 | Embodiment 2 | Embodiment 3 | Embodiment 4 |
| TTL/f | 0.82 | 0.84 | 0.77 | 0.83 |
| f4/(R7-R8) | −0.16 | −0.40 | −0.05 | −0.05 |
| (d2/f)*100 | 9.22 | 3.00 | 12.54 | 14.72 |
| (43.25/(2*IH))*f | 65.57 | 65.50 | 71.28 | 68.99 |
| f4/f5 | −0.79 | −0.40 | −0.84 | −1.02 |
| f | 7.580 | 7.572 | 7.977 | 7.976 |
| f1 | 3.489 | 3.499 | 3.533 | 3.855 |
| f2 | −7.144 | −10.757 | −5.229 | −6.178 |
| f3 | −7.725 | −6.297 | −8.875 | −9.508 |
| f4 | −4.572 | −5.747 | −4.214 | −2.562 |
| f5 | 5.767 | 14.367 | 5.000 | 2.502 |
| FNO | 2.495 | 2.495 | 2.495 | 2.495 |
| TTL | 6.200 | 6.360 | 6.143 | 6.600 |
| IH | 2.500 | 2.500 | 2.420 | 2.500 |
| FOV | 36.10° | 35.53° | 33.91° | 32.29° |

Those skilled in the art should understand that the above embodiments are just specific embodiments for implementing the present disclosure, and in practical applications, various changes may be implemented in form and detail without departing from the spirit and scope of the present disclosure.

What is claimed is:

1. A camera optical lens, comprising from an object side to an image side:
a first lens having a positive refractive power;
a second lens having a negative refractive power;
a third lens having a negative refractive power;
a fourth lens having a negative refractive power; and
a fifth lens having a positive refractive power,
wherein a focal length of the camera optical lens is f, a total track length of the camera optical lens is TTL, an on-axis distance from an image side surface of the first lens to an object side surface of the second lens is d2, a focal length of the fourth lens is f4, a central curvature radius of an object side surface of the fourth lens is R7, and a central curvature radius of an image side surface of the fourth lens is R8, and following relational expressions are satisfied:
$$0.75 \leq TTL / f \leq 0.84 ;$$
$$2.99 \leq ( d 2 / f ) * 100 \leq 15. ; and$$
$$- 0.4 \leq f 4 / ( R 7 - R 8 ) \leq - 0.05 .$$

2. The camera optical lens as described in claim 1, wherein an image height of the camera optical lens is IH, and a following relational expression is satisfied:
$$65.49 \leq ( 43.25 / ( 2 * IH ) ) * f \leq 71.5 .$$

3. The camera optical lens as described in claim 1, wherein a focal length of the fifth lens is f5, and a following relational expression is satisfied:
$$- 1.05 \leq f 4 / f 5 \leq - 0.4 .$$

4. The camera optical lens as described in claim 3, wherein
$$- 1.03 \leq f 4 / f 5 \leq - 0.4 .$$

5. The camera optical lens as described in claim 1, wherein an object side surface of the first lens is convex in a paraxial region, and
wherein a focal length of the first lens is f1, a central curvature radius of the object side surface of the first lens is R1, a central curvature radius of the image side surface of the first lens is R2, and an on-axis thickness of the first lens is d1, and following relational expressions are satisfied:
$$0.44 \leq f 1 / f \leq 0.49 ;$$
$$- 1.04 \leq ( R 1 + R 2 ) / ( R 1 - R 2 ) \leq 0.77 ; and$$
$$0.145 \leq d 1 / TTL \leq 0.244 .$$

6. The camera optical lens as described in claim 1, wherein the object side surface of the second lens is convex in a paraxial region, and an image side surface of the second lens is concave in the paraxial region, and
wherein a focal length of the second lens is f2, a central curvature radius of the object side surface of the second lens is R3, a central curvature radius of an image side surface of the second lens is R4, and an on-axis thickness of the second lens is d3, and following relational expressions are satisfied:
$$- 1.43 \leq f 2 / f \leq - 0.65 ;$$
$$1.53 \leq ( R 3 + R 4 ) / ( R 3 - R 4 ) \leq 2.82 ; and$$
$$0.026 \leq d 3 / TTL \leq 0.033 .$$

7. The camera optical lens as described in claim 1, wherein an image side surface of the third lens is concave in a paraxial region, and
wherein a focal length of the third lens is f3, a central curvature radius of an object side surface of the third lens is R5, a central curvature radius of the image side surface of the third lens is R6, and an on-axis thickness of the third lens is d5, and following relational expressions are satisfied:
$$- 1.2 \leq f 3 / f \leq - 0.83 ;$$
$$0.73 \leq ( R 5 + R 6 ) / ( R 5 - R 6 ) \leq 1.8 ; and$$
$$0.028 \leq d 5 / TTL \leq 0.039 .$$

8. The camera optical lens as described in claim 1, wherein the object side surface of the fourth lens is concave in a paraxial region, and the image side surface of the fourth lens is convex in the paraxial region, and
wherein an on-axis thickness of the fourth lens is d7, and following relational expressions are satisfied:
$$- 0.76 \leq f 4 / f \leq - 0.32 ;$$
$$- 1.37 \leq ( R 7 + R 8 ) / ( R 7 - R 8 ) \leq - 1.05 ; and$$
$$0.026 \leq d 7 / TTL \leq 0.038 .$$

9. The camera optical lens as described in claim 1, wherein an image side surface of the fifth lens is convex in a paraxial region, and
wherein a focal length of the fifth lens is f5, a central curvature radius of an object side surface of the fifth lens is R9, a central curvature radius of the image side surface of the fifth lens is R10, and an on-axis thickness of the fifth lens is d9, and following relational expressions are satisfied:
$$0.31 \leq f 5 / f \leq 1.9 ;$$
$$- 0.34 \leq ( R 9 + R 10 ) / ( R 9 - R 10 ) \leq 1.98 ; and$$
$$0.111 \leq d 9 / TTL \leq 0.163 .$$

10. The camera optical lens as described in claim 1, wherein the first lens is made of glass.
